(19) United States
(12) Patent Application Publication
(10) Pub. No.: US 2026/0136169 A1
(43) Pub. Date: May 14, 2026

(54) PRIORITY MODEL FOR ESTABLISHING CONNECTIONS BETWEEN DEVICES

(71) Applicant: QUALCOMM Incorporated, San Diego, CA (US)

(72) Inventors: Anusha HARLAPUR, Dharwad (IN); Surya Srujan KHANDAVILLI, Hyderabad (IN)

(21) Appl. No.: 18/948,390

(22) Filed: Nov. 14, 2024

(51) Int. Cl. H04W 8/00; H04W 48/20; H04W 76/10

(52) U.S. Cl. CPC H04W 8/005; H04W 48/20; H04W 76/10

(57) ABSTRACT

This disclosure provides methods, components, devices and systems for providing priority connections between linked devices in a wireless network. Some aspects more specifically relate to generating and using a priority model to provide for a source device to connect to a target device in a secure device ecosystem. In some examples, the priority model for the source device can be associated with a connection type or a type of data exchanged in a connection between the source device and the target device. In some examples, the source device establishes a connection of the connection type to the target device. In some aspects, the source device or a network device in the secure device ecosystem generates the priority model for target device selection using priority preferences for various target devices and generates a priority model with priority preferences received from a user or built using a learning model.

### TECHNICAL FIELD

This disclosure relates generally to wireless communication, and more specifically, to generating and utilizing a priority model for establishing a wireless connection between wireless communication devices in a secure wireless communication environment.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices ma y communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

One innovative aspect of the subject matter described in this disclosure can be implemented in a wireless communication device or source device which includes a processing system including processor circuitry and memory circuitry that stores code. In some aspects the processing system is configured to cause the source device to scan a wireless medium for a plurality of target devices linked to the source device in a secure device ecosystem, select, using a priority model for the source device and a connection type, a primary target device for the connection type from the plurality of target devices, and establish a connection of the connection type to the primary target device.

In some examples, the techniques described herein relate to a source device, where selecting the primary target device further includes selecting a secondary target device from the plurality of target devices when a primary target device is not detected in the scan of the wireless medium.

In some examples, the techniques described herein relate to a source device, where the processing system is further configured to cause the source device to receive a multiple connection approval input at the source device and establish at least one additional connection of the connection type to a secondary target device of the plurality of target devices.

In some examples, the techniques described herein relate to a source device, where the connection type includes a type of data exchanged between the source device and a target device, and where the connection type includes one or more of: an audio connection, a video connection, a multimedia connection, and an immersive data stream connection.

In some examples, the techniques described herein relate to a source device, where the processing system is further configured to cause the source device to receive a priority preference for a target device of the plurality of target devices and update the priority model using the priority preference for the target device.

In examples, the techniques described herein relate to a source device, where the priority model includes a preference matrix for a plurality of devices in the secure device ecosystem.

In some aspects, the techniques described herein relate to a source device, where the processing system is further configured to cause the source device to update the priority model using a priority model update received from the secure device ecosystem.

One innovative aspect of the subject matter described in this disclosure can be implemented in a wireless communication device or network device. The network device includes a processing system that includes processor circuitry and memory circuitry that stores code. In some examples, the processing system is configured to cause the network device to scan a wireless medium for a plurality of target devices linked to a source device in a secure device ecosystem, receive a priority preference for target device in the plurality of target devices, a priority model for connecting the source device to a target device being generated using the received priority preferences, and broadcast the priority model to a plurality of source devices in the secure device ecosystem.

In some examples, the techniques described herein relate to a network device, where the priority preference includes a selected priority preference. In some examples, generating the priority model further includes receiving a selected priority preference for each target device in the plurality of target devices and storing the selected priority preferences in the priority model for an associated source device.

In some examples, the techniques described herein relate to a network device, where the priority preference for each of the target devices includes a plurality of connection selections. In some examples, generating the priority model further includes receiving the plurality of connection selections for one or more target devices of the plurality of target devices, generating, using a learning model, a learned priority preference for the target device using the plurality of connection selections, and storing the learned priority preference in the priority model for an associated source device.

Another innovative aspect of the subject matter described in this disclosure can be implemented in a method for by a wireless communication device or source device. The method includes scanning a wireless medium for a plurality of target devices linked to the source device in a secure device ecosystem, selecting, using a priority model for the source device and a connection type, a primary target device for the connection type from the plurality of target devices, and establishing a connection of the connection type to the primary target device.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIG. 3 shows a pictorial diagram of an example secure device ecosystem.

FIG. 4 shows a pictorial diagram of an example source device in a secure device ecosystem arrangement.

FIGS. 5A and 5B show pictorial diagrams of example preference matrix priority models.

FIG. 6 shows a flowchart illustrating an example process performable by or at a network device for generating a priority model for connecting a source device to a target device.

FIG. 7 shows a flowchart illustrating an example process performable by or at a network device for establishing a connection between a source and a target device.

FIG. 8 shows a flowchart illustrating an example process performable by or at a network device that supports generating a priority model for connecting a source device to a target device.

FIG. 9 shows a flowchart illustrating an example process performable by or at a network device that supports generating a priority model for connecting a source device to a target device.

FIG. 10 shows a flowchart illustrating an example process performable by or at a source device that supports establishing a connection between the source and a target device.

FIG. 11 shows a flowchart illustrating an example process performable by or at a source device that supports establishing a connection between the source and multiple target devices.

FIG. 12 shows a flowchart illustrating an example process performable by or at a source device that supports updating a priority model at a source device.

FIG. 13 shows a block diagram of an example wireless communication device that supports generating and utilizing a priority model for connecting a source device to a target device.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Wireless communication networks increasingly include wireless communication devices that may connect to a wide area network, such as the Internet, as well as directly connect to other devices, such as other devices in a secure device ecosystem. For example, many consumer devices, such as smartphones, laptops, tablets and extended reality (XR) consoles/devices, among many other examples, are able to function as connection source devices and establish direct wireless connections to other connection target devices in the secure device ecosystem. These target devices can include headphones, speakers, smart watches, XR devices and other wireless network devices that are also authenticated to the secure device ecosystem. For example, a smartphone may connect to headphones to play an audio stream from the smartphone through the headphones. In some examples, wireless communication devices, including both source and target devices, may be paired, linked or bonded to many devices. In this example, a source device first selects a paired device to connect to before establishing a connection between the devices. For example, a smartphone may be paired to several different headphones sets and a set of speakers where the smartphone first selects which of the headphones or speakers to connect to prior to beginning to stream the audio to the selected target device.

In some examples, the presence of multiple paired devices within a connectable distance may cause a source device to select and connect to a device that is not preferred by a user of the source device. For example, the smartphone may first connect to a paired speaker when the user prefers to use paired headphones. In this case, to change the connection to the preferred device, the user often manually interacts with some combination of the smartphone, the speaker and the headphones in order to establish the desired connection. As the number and types of devices able to utilize direct connections between devices increases, the likelihood of non-desired connections also increases. The unpredictability of automatic connection processes can increase user frustration with the devices as well as waste device and network resources during frequent manual selection or reselection process needed to establish the desired connection.

Various aspects relate generally to wireless communication and more particularly to providing priority connections between linked devices in a wireless network. Some aspects more specifically relate to generating and using a priority model to provide for a source device to connect to a primary target device for a connection type in a secure device ecosystem. In some examples, a source device in a wireless network, such as the secure device ecosystem, may scan a wireless medium to detect or otherwise identify multiple target devices linked or paired to the source device. The source device selects, using a priority model for the source device, a primary target device for the connection type from the multiple target devices. In some examples, the priority model for the source device can be associated with a connection type for a connection between the source device and the target device. In some examples, the connection type is based on a type of data exchanged between the source device and the target device and may include one or more of an audio connection, a video connection, and a multimedia connection. For example, the target device may include an XR device where the connection type includes an immersive experience data stream. In some examples, the source device establishes a connection of the connection type to the primary target device.

In some aspects, the source device or a network device in the secure device ecosystem generates the priority model for the target device selection. For example, the network device scans a wireless medium for a plurality of target devices linked to the source device in the secure device ecosystem. In some examples, the network device receives priority preferences for each of the scanned target devices and generates a priority model with a priority preference for each of the scanned target devices. In some examples, the priority preference includes preferences received from a user which identifies the target device and the associated preference ranking. In another example, the priority model is built using a learning model. For example, a learning model determines a priority for a target device using connection selections related to the target device received or observed at the source device. In some examples, the learning model may be trained using artificial intelligence/machine learning (AI/ML) models, such as reinforcement learning, to predict a priority preference for each target device and source device. In some examples, the priority model also can be broadcast or otherwise provided to other devices in the secure device ecosystem.

Particular aspects of the subject matter described in this disclosure can be implemented to realize one or more of the following potential advantages. Source devices directly connecting to primary target devices can provide for seamless transitions for various connection types from the source device to the target device. By using a priority model to select and connect a target device to a source device, connection interruptions, such as interruptions in data flows can be avoided or eliminated. Additionally, the use of connection-based priority models increases a number of connection based primary target devices to which a source device can connect, depending on a which type of connection is utilized at the primary target device. For example, the source device may connect to a first primary target device for a first connection type and connect to second primary target type for a second connection type. The flexibility in connecting different primary target devices based on the type of connection can further avoid confusion and delay in the connection process between the source and target devices. In some additional aspects, the use of preferences received from a user in the priority model provides for the source device to connect to target devices may be based on adjustable and defined preferences. In another example, the use of a learning model to determine priority selections based on connection selections over time, can provide for the source device to efficiently connect to primary target devices, without manual intervention, and to update the preferences based on observed behavior over time.

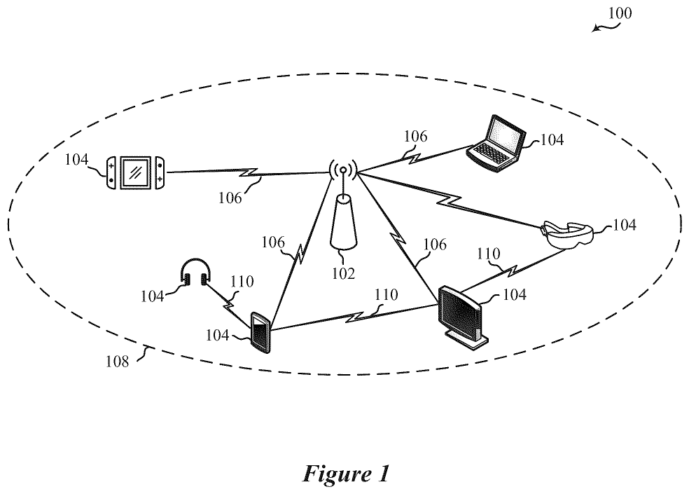

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

In some wireless communication systems, wireless communication devices (such as an AP 102 and STAs 104 described with reference to FIG. 1) may operate via one or more wireless communication links in a frequency band higher than a sub- 7 GHz (sub 7, such as a 2.4 GHz frequency band, a 5 GHz frequency band, or a 6 GHz frequency band) frequency band. In some such wireless communication systems, the AP 102 and STAs 104 may communicate on a wireless communication link in a millimeter wave (“mmWave” or “mmW”) band (for example, a frequency band between 30 GHz and 300 GHz, such as a 60 GHz frequency band). A wireless communication system supporting such mmWave communications (such as AP 102 and STAs 104 in wireless communication network 100) may use integrated mmWave (IMMW) techniques to support operations in these frequency bands. To manage the relatively high attenuation losses and other path losses associated with the mmWave band, the AP 102 and STAs 104 may transmit and receive directional communications via beamforming procedures. To select or otherwise generate directional beams in the mmWave band, a wireless communication device may perform beam sweeping, searching and training operations, which may involve various training and feedback reporting packet sequences. In some wireless communication systems, a mmWave link supports data communications while a sub7 link may be used for management and control information signaling to support the mmWave communications. For example, a STA 104 may first associate with an AP 102 to establish a sub7 link, and thereafter, perform beam searching and training in the mmWave band to establish a mmWave link for the communication of data. In such examples, the sub7 link may be referred to as an anchor link.

In addition to beam searching and training procedures, an AP 102 and a STA 104, after having selected a beam pair, may perform beam management and recovery procedures, including periodic beacon-based procedures and aperiodic STA-initiated fast link recovery procedures, which may involve the use of beam recovery sequences. The AP 102 and STAs 104 may use these beam management and recovery procedures for beam sync-up and identifying broken links. When communicating via a mmWave link, the AP 102 and STAs 104 may perform various channel access procedures including contention-based access procedures, target wake time (TWT)-based access procedures (including the use of dedicated and opportunistic service periods (SPs)), scheduled-mode access procedures, and triggered-mode access procedures. The APs 102 and STAs 104 operating in the mmWave band also may support various management frame optimizations and procedures including optimizations and procedures associated with discovery, scanning, association, roaming, link setup, updates and maintenance, and the initial and continuing configuration of BSS and link-specific parameters including channel selection and rate adaptation. To support or facilitate communication in the mmWave band, the APs 102 and STAs 104 also may make use of various PHY layer enhancements, such as additional bandwidth modes, numerologies, tone plans, preamble designs, codebook designs, waveform designs, new PPDU formats or reuse of existing sub-7 GHz PPDU formats for mmWave frequencies. Particular RF and analog designs, such as RF front end designs, antenna integration designs, and conversion architecture designs, may be implemented in APs 102 and STAs 104 to support mmWave operation.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QoS) parameters. For example, existing technology (such as IEEE 802.11ax standard amendment protocols) supports the use of up to 1024-quadrature amplitude modulation (QAM), where a modulated symbol carries 10 bits. To further improve peak data rate, each of the AP 102 or the STA 104 may employ use of 4096-QAM (also referred to as “4k QAM”), which enables a modulated symbol to carry 12 bits. 4 k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 μs per OFDM symbol). The AP 102 or the STA 104 using 4096-QAM may enable a 20% increase in data rate compared to 1024-QAM given the same coding rate, thereby allowing users to obtain higher transmission efficiency.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields).

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (for example, one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (for example, monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

A wireless communication device may include an auxiliary radio and a main radio and may operate in both an auxiliary radio mode and a main radio mode. The wireless communication device may be a STA or an AP, such as, for example, the AP 102 and STAs 104 described with reference to FIG. 1. Additionally, the wireless communication device may support communications over a single wireless link or over multiple wireless links. For example, the wireless communication device may be an AP MLD or a non-AP MLD. The auxiliary radio mode may support communications with relatively lower data rates (such as ≤24 Mbps) than the main radio mode. For example, while operating in an auxiliary radio mode, the auxiliary radio of the wireless communication device may transmit messages having a non-high throughput (non-HT) format whereas, while operating in a main radio mode, the main radio may transmit messages having an EHT, UHR or later protocol format. A wireless communication device that uses an auxiliary radio in addition to a main radio may improve reliability and reduce latency and power consumption. For example, the wireless communication device may improve reliability by using the auxiliary radio to transmit/receive redundancies, facilitate fast feedback exchanges, or otherwise increase robustness for high-priority or otherwise important packets (for example, packets containing latency-sensitive traffic or traffic requiring high reliability). For example, to support latency-sensitive traffic insertion in uplink communications, an AP may utilize its auxiliary radio for detection of low latency PPDU (LL-PPDU) subframes associated with latency-sensitive traffic. As another example, the wireless communication device also may use the auxiliary radio to scan for channels while communicating on another channel via the main radio, thereby reducing latency associated with a transition between channels by eliminating the time for the main radio to scan for channels. As another example, use of the auxiliary radio may reduce power consumption by enabling the main radio to enter a sleep mode and monitoring for wake-up signals via the auxiliary radio, which is designed to consume less power than the main radio.

The auxiliary radio may support both transmitting and receiving (Tx/Rx) modes of operation, or may support receiving-only (Rx-only) modes of operation. If the wireless communication device is an MLD, the wireless communication device may communicate on one or more wireless links using a main radio and may simultaneously communicate on one or more wireless links using one or more auxiliary radios. In an MLD scenario in which the auxiliary radio is Rx-only capable (an “Aux-Rx” mode), the wireless communication device may transmit and receive communications on a first wireless link using the main radio but may simultaneously receive (but not transmit) communications on a second wireless link using the auxiliary radio. In an MLD scenario in which the auxiliary radio is Tx/Rx capable (an “Aux-Tx/Rx” mode), the wireless communication device may transmit and receive communications on a first wireless link using the main radio and may simultaneously transmit and receive communications on a second wireless link using the auxiliary radio. In an MLD scenario, the wireless communication device may transition the main radio from a second wireless link to a first wireless link and may correspondingly transition the auxiliary radio from the first wireless link to the second wireless link. For example, the wireless communication device's auxiliary radio may receive control signaling on the second wireless link from another wireless communication device that triggers the wireless communication device to switch the use of its radios between wireless links. If the wireless communication device is not an MLD, the wireless communication device may transition from using its auxiliary radio to using its main radio mode on a single wireless link. For example, the wireless communication device's auxiliary radio may receive control signaling from another wireless communication device that triggers the wireless communication device to initiate the transition from use of the auxiliary radio to the main radio on the wireless link. Upon such a transition, the wireless communication device may place the auxiliary radio in a powered-down sleep state while activating the main radio to an awake state. Similarly, the wireless communication may transition from using its main radio to its auxiliary radio on the wireless link upon receiving a triggering control signal.

In some examples, the wireless communication device (such as a STA) may indicate (for example, via a broadcast frame such as a beacon frame or other management frame), to other wireless communication devices (such as an AP), parameters associated with an auxiliary radio mode or parameters associated with transitioning from the auxiliary radio mode to a main radio mode for a given wireless link. For example, the wireless communication device may indicate a message format for the auxiliary radio mode. The indicated message format may be associated with a particular PPDU format (such as non-HT) or a supported data rate (such as ≤24 Mbps).

In some examples, the wireless communication device may indicate transition delays corresponding to time durations associated with switching from the auxiliary mode to the main radio mode as well as switching from the main radio mode to the auxiliary radio mode for a wireless link. A second wireless communication device may schedule data communications with the wireless communication device based on the transition delay so that data is not transmitted to the wireless communication device during the transition delay, during which data may be lost. The duration of the transition delay may generally be dependent on whether the auxiliary radio supports Tx/Rx or Rx-only modes of operation. For example, if the auxiliary radio supports Tx/Rx, the auxiliary radio may transmit an acknowledgment message in response to a request to transition to the main radio mode for a wireless link, which may extend the transition delay. Additionally, or alternatively, the duration of the transition delay may depend on whether the main radio is transitioning from a sleep mode or from a different wireless link.

The auxiliary radio may perform additional functions while the wireless communication device communicates with a second wireless communication device via a wireless link using the main radio. The functions that may be performed may generally depend on whether the auxiliary radio supports Tx/Rx or Rx-only modes of operation or whether the wireless communication device is an MLD capable of supporting communications over more than one wireless link. For example, in an Aux-Rx mode, the auxiliary radio of a wireless communication device (such as a non-AP MLD) may monitor or collect channel state (or quality) information or statistics (such as BSS load, interference profiles of neighboring BSSs and multi-NAV multi-primary maintenance) in a passive manner. In an Aux Tx/Rx mode, the auxiliary radio of the non-AP MLD may monitor or collect channel state information or statistics as well as transmit a report to an AP MLD that includes the collected channel state information or statistics without involvement of the main radio. In some examples, while operating in an Aux-Rx mode, a first wireless communication device (such as an AP MLD) may use the auxiliary radio to receive control communications or high-priority or otherwise important data communications from the second wireless communication device (such as another AP MLD) using a second wireless link while its main radio uses the first wireless link to perform data transfer. In contrast, in an Aux-Tx/Rx mode, an AP MLD may use the auxiliary radio to both receive and transmit control communications or high-priority or otherwise important data communications. In some examples, while operating in an Aux-Rx mode, a non-AP MLD's auxiliary radio may monitor or scan for potential APs to associate with on alternative wireless channels than the wireless channel on which the non-AP MLD's main radio is still communicating with a previously connected AP. In an Aux-Tx/Rx mode, an MLD may use the auxiliary radio to both scan for and perform association or authentication on other wireless channels. Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and update the output based on a combination of the input data and the weights.

STAs or APs (for example, a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QoS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (for example, some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

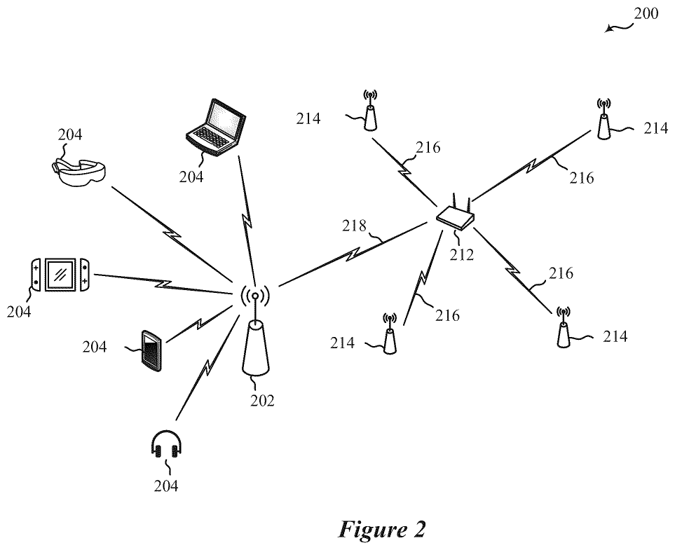

FIG. 2 shows a pictorial diagram of another example wireless communication network 200. According to some aspects, the wireless communication network 200 can be an example of a mesh network, an IoT network or a sensor network in accordance with one or more of the IEEE 802.11 family of wireless communication protocol standards (including the 802.11ah amendment). The wireless communication network 200 may include multiple wireless communication devices 214, which in some implementations may include APs 202, STAs 204, or both. The wireless communication devices 214 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 214 sense, measure, collect or otherwise obtain and process data and transmit such raw or processed data to an intermediate device 212 for subsequent processing or distribution. Additionally, or alternatively, the intermediate device 212 may transmit control information, digital content (for example, audio or video data), configuration information or other instructions to the wireless communication devices 214. The intermediate device 212 and the wireless communication devices 214 can communicate with one another via wireless communication links 216. In some examples, the wireless communication links 216 include Bluetooth links, or other PAN or short-range communication links.

In some examples, the intermediate device 212 also may be configured for wireless communication with other networks such as with a WLAN or a wireless (for example, cellular) wide area network (WWAN), which may, in turn, provide access to external networks including the Internet. For example, the intermediate device 212 may associate and communicate, over a Wi-Fi link 218, with an AP 202 of a wireless communication network 200, which also may serve various STAs 204. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

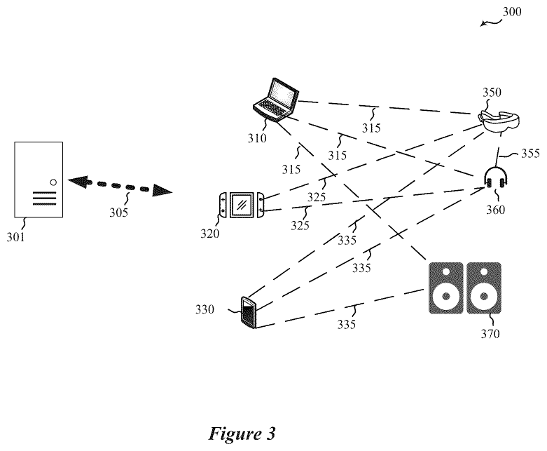

FIG. 3 shows a pictorial diagram of an example secure device ecosystem 300. In some examples, the secure device ecosystem 300 includes a secure device server 301 and various devices communicatively connected to the secure device server 301 via communication link 305. In some implementations, each of the devices in the secure device ecosystem 300 may generate and use a priority model to provide for a source device to connect to a primary target device for a given connection type in the secure device ecosystem 300. For example, the secure device ecosystem 300 includes devices such as source devices 310, 320 and 330, target devices 350, 360 and 370. In some examples, the source device and target devices described may be similar to the APs 102 and STAs 104 described in further detail reference to FIG. 1. Additionally, the source devices and target devices described also may be similar to the APs 202, intermediate device 212 and STAs 204 described in further detail with reference to FIG. 2.

In some examples, the various devices are wireless communication devices, such as STAs, APs or other network devices, which are authenticated to a multi-device identification service. For example, the multi-device identification service may provide registration and authentication to the wireless communication devices in the secure device ecosystem 300 as trusted devices via the secure device server 301 or other secure device authentication service. In some examples, the trusted devices may securely communicate with other trusted devices in the secure device ecosystem 300. For example, the trusted devices may communicate data for the secure device ecosystem 300, such as priority models or other secure information between the trusted devices without requiring additional security processes in the communication via the communication link 305 and other communication channels/links described herein.

In some examples, the trusted devices in the secure device ecosystem 300 may be paired, bonded or otherwise connected to other trusted devices. For example, the trusted devices may be bonded or connected via pair links, such as a Bluetooth pairing links or other wireless communication bonds between trusted devices, including source and target devices. The pair links provide for a quick and resource saving method for the devices to interact and establish wireless connections, whenever the devices are within a wireless communication range. For example, source device 310 is linked to the target devices 350, 360 and 370 via pair links 315. Additionally, the source device 320 is linked to the target device 350 and the target device 360 via pair links 325 and the source device 330 is linked to the target devices 350, 360 and 370 via the pair links 335. In some examples, the target device 350 is a source/target device capable of serving as a source device as well as a target device and is also linked to the target device 360 via a pair link 355. In some implementations, the pair links provide a link for quick and efficient establishment of a data connection between the paired source device and target device. For example, the source device 320 may establish an audio connection to the target device 360 using the pair link 325.

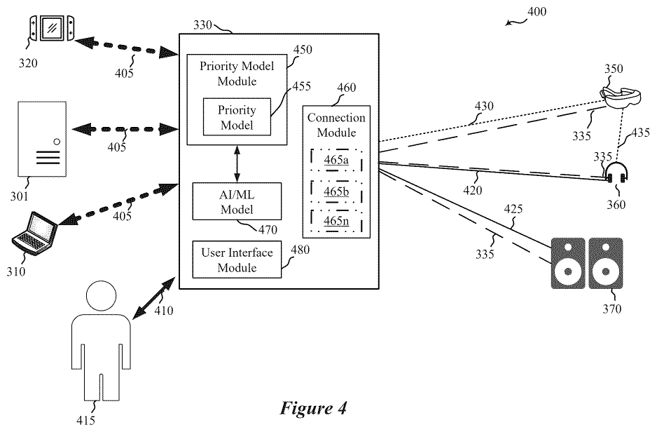

In some examples, the selection of which target device a source device connects to for a given connection type may result in undesired connections. For example, the source device 310 may establish a connection to the target device 370, when a desired connection for the given connection type would be to the target device 360. In some implementations the wireless communication devices, including the source devices 310, 320 and 330, among other devices, generate and use a priority model to provide for the source device to connect to a primary target device for a connection type in a secure device ecosystem 300. In some examples, the use of the priority model provides more seamless and efficient transitions for various connection types from a given source device to the target devices. For example, using a priority model to select and connect one or more target devices to a source device in the secure device ecosystem 300 reduces or eliminates connection interruptions, such as interruptions in data flows in the connection. For example, the source device 310, using the priority model, directly connects to the target device 360 (headphones) for an audio connection, thus avoiding manual user intervention in transferring the connection to the correct device, while also conserving device and network resource that would be wasted in establishing a connection to a non-preferred device. Generating and using priority models for connection in the secure device ecosystem 300 is described in greater detail with reference to FIGS. 4-12.

FIG. 4 shows a pictorial diagram of an example source device 330 in a secure device ecosystem arrangement 400. In some examples, the source device uses a priority model to select a primary target device for a connection type from multiple target devices in the arrangement 400. In some examples, the arrangement 400 is within the secure device ecosystem 300 described with reference to FIG. 3 and is in communication with the secure device server 301 and source devices 310 and 320. In some examples, the source device 330 is linked via the pair links 335 to the target devices 350, 360 and 370. In some examples, the source device 330 also may be paired or linked to other targets devices not shown in FIG. 4. In the arrangement 400, the target devices 350, 360 and 370 are within a connection range of the source device 330 such that the source device 330 may detect the target devices in a scan of the wireless medium and establish a connection with one or more of the devices. For example, the source device 330 may scan a wireless medium for target devices linked to the source device 330 in the secure device ecosystem and begin the priority model generation methods and selection methods described herein.

In some implementations, to generate and use priority models for various connection types, the source device 330 includes a user interface (UI) module 480 which provides an interactive interface for a user 415 to receive information outputted from the source device 330 and for the user 415 to provide inputs to the source device 330 via input/outputs 410. For example, the source device 330, via the UI module 480 and associated interface may request user preferences, such as a priority preference or ranked preference for each of the target devices, including the target devices 350, 360 and 370. In some examples, the module 480 also may request or receive connection selections for the target devices from the user 415. For example, the source device 330 may request the user to select which target device to establish a connection to for a connection type. In some examples, the use of connection-based priority models increases a number of connection based primary target devices to which a source device can connect, depending on a which type of connection is utilized at the primary target device. For example, the source device 330 may connect to a first primary target device for a first connection type, such as an audio connection, and connect to second primary target device for a second connection type, such as a video or multimedia connection. For example, the source device 330 may request which device the user would like to connect and the user may select target device 360 (headphones) as a primary target device for a music connection (audio connection) during the general use of the source device 330.

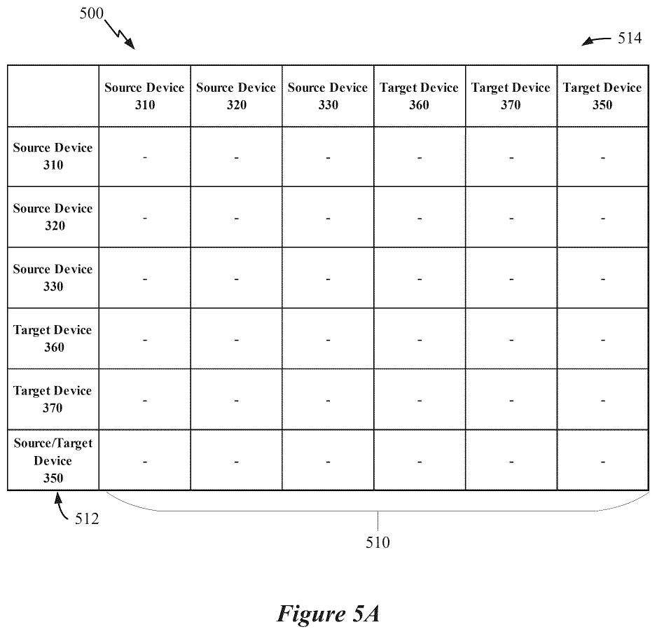

For a different connection type, such as an immersive data stream connection, the user may select target device 350 (such as an XR headset) as the priority target device for the immersive data stream connection. In some implementations, the source device 330 also includes a priority model module 450, which stores a priority model 455 for the source device 330 which provides for establishing connections to the target devices. In some examples, the priority model 455 is a preference matrix as described in more detail with reference to FIGS. 5A and 5B. The priority model 455 also may take the form of other similar data structures which provide for identifying and storing preferences for the target devices. In some implementations, the source device 330 also includes AI/ML model 470 to support prediction of priority preferences for the source device 330. In some examples, the AI/ML model 470 is similar to the AI/ML models described in further detail with reference to FIG. 1.

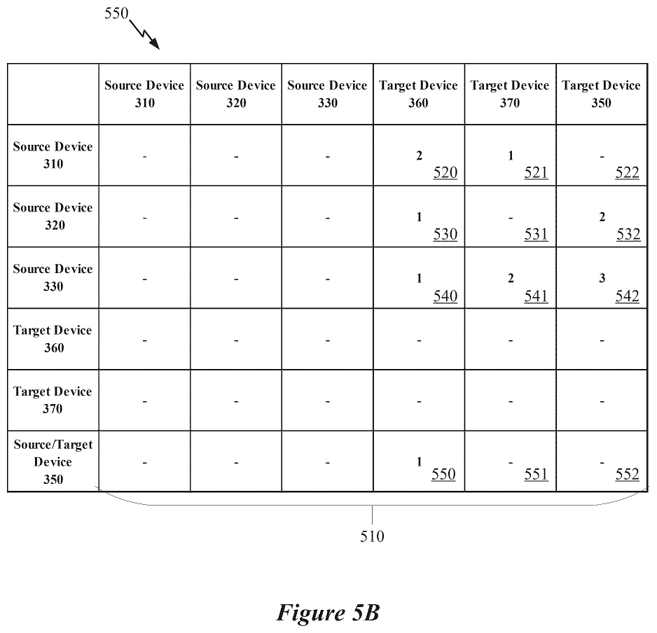

In some examples, the priority model module 450 may receive the priority model 455 or updates for the priority model 455 from other devices in the secure device ecosystem 300. For example, the source devices 310 and 320 or the secure device server 301 may provide the priority model 455 or updates to the priority model 455 to the source device 330 via connections 405. In some examples, the priority model module 450 may generate the priority model 455 using inputs received from the user 415. The priority model module 450 also may generate or update the priority model 455 using inputs received from the user 415 (and other connection selections made at the source device 330) and an AI/ML model 470. For example, when a user declines to provide primary target preferences, the priority model module 450, the AI/ML model 470 may be trained to identify patterns or relationships in the selections of target devices and establishment of connections to learn which device is a preferred device of the user (or other users) for a given connection and generate/update the priority model 455 using the learned selections and preferences. Example processes for generating the priority model are described in more detail with reference to FIG. 6.

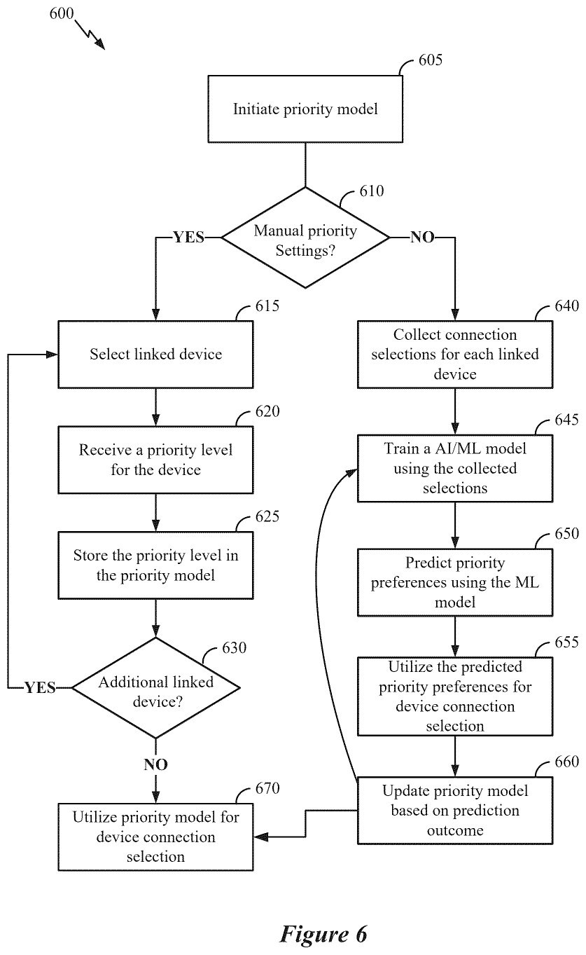

In some examples, the connection module 460 establishes connections with the target devices based on the connection type of the connection and a target device selected by the priority model module 450. For example, connections 465a-465n may be different types of connections, including one or any combination of an audio connection, a video connection, a multimedia connection, and an immersive data stream connection, where each connection type includes a different type of data to be exchanged between the source device 330 and a target device selected by the priority model module 450 and the module 460. For example, the connection module 460 may establish an audio connection 420 to target device 360 (headphones) and an audio connection 425 to the target device 370 (speakers) at different times or simultaneously as described in more detail with reference to FIG. 7 herein. In some examples, the connection module 460 also may establish an immersive data stream connection 430 to the target device 350. The target device 350 may serve as a source/target device which also may connect with other target devices. For example, the target device 350 may establish an audio connection 435 to the target device 360 simultaneous to the immersive data stream connection 430 from the source device 330 or independently as a source device. Example processes for using the priority model to select a primary target device and establish a connection are described in more detail with reference to FIG. 7.

FIGS. 5A and 5B show pictorial diagrams of example preference matrix priority models. FIG. 5A shows an initialized preference matrix 500 prior to storage of priority preferences. For example, a source device may initialize or generate a blank preference matrix for the source device and connection type prior to populating the matrix with priority preferences. In some examples, the matrix 500 includes fields 510 for storing priority preferences for the various devices in the secure device ecosystem 300. In some examples, the matrix 500 includes a listing of every target and source device in the secure device ecosystem 300 arranged in column 512 along with a corresponding listing of every target device and source device in the secure device ecosystem 300 arranged in row 514. In some examples, a network device, such as the source device 330 or other devices described with reference to FIGS. 3 and 4, stores a priority preference for a given source device/target device pair in a corresponding field of the fields 510 as described in more detail with reference to FIG. 5B.

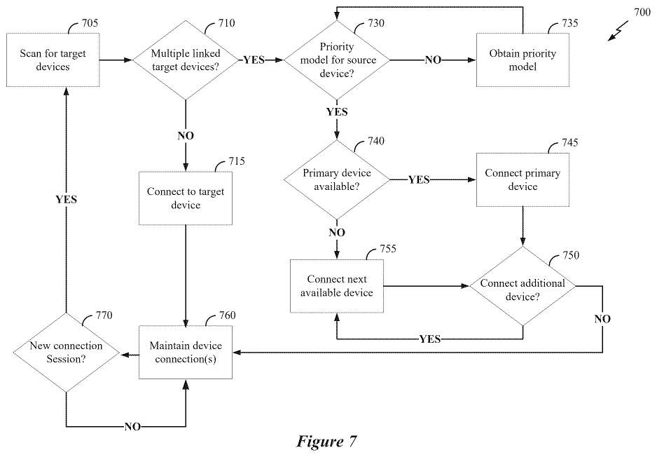

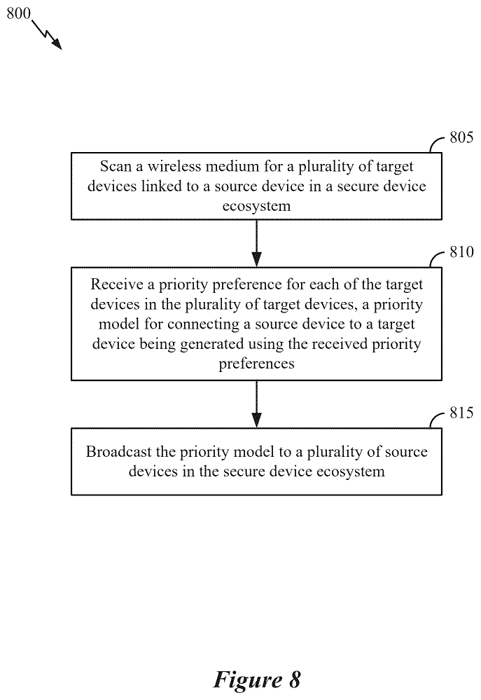

FIG. 5B shows a preference matrix 550 for the secure device ecosystem 300 described with reference to FIGS. 3 and 4. In some examples, the source device 310 includes priority preferences for the target devices 350, 360 and 370. For example, the source device 310 includes a primary preference to connect to target device 370 which is stored as “1” in field 521 of the fields 510. The source device 310 also includes a secondary preference for target device 360, stored as “2” in field 520. In some examples, when a priority preference has not been received for a device pair in the matrix or the device pair is not paired/linked, the respective field is left null. For example, source device 310 is not paired to device 350, where the field 522 left blank or null since no preference has been received/will be received. Generating a preference matrix priority model is described in more detail with reference to FIGS. 6 and 8. Additionally, using the preference matrix priority model to establish a connection between a target and source device is described in more detail with reference to FIGS. 7 and 9.

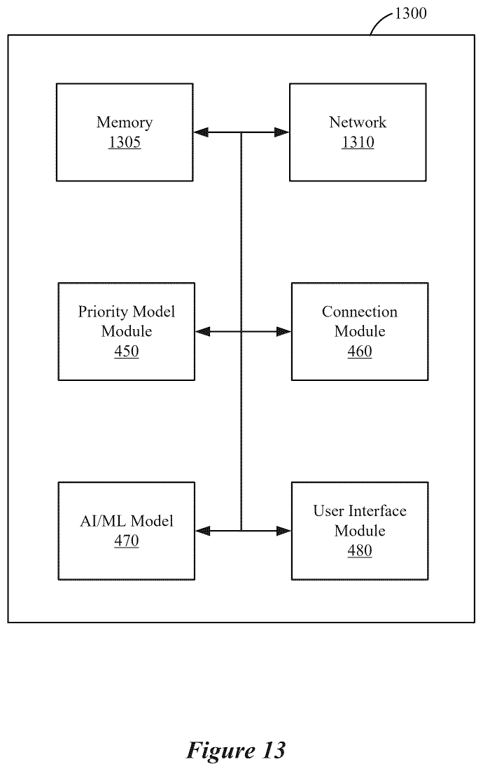

FIG. 6 shows a flowchart illustrating an example process 600 performable by or at a network device for generating a priority model for connecting a source device to a target device. The operations of the process 600 may be implemented by a source device or its components as described herein. For example, the process 600 may be performed by a wireless communication device, such as the wireless communication device 1300 described with reference to FIG. 13, operating as or within a STA including any of the STAs 104 and 204 and source devices described with reference to FIGS. 1-3. In some examples, the process 600 may be also performed by a wireless AP such as one of the APs 102 or 202 described with reference to FIGS. 1 and 2.

In some examples, in block 605, the priority model module 450 initiates the priority model 455 for a connection. For example, the priority model module 450 generates or creates the priority model 455 on the source device 330 as described with reference to FIG. 4. In some examples, the generated priority model 455 is the preference matrix 500 described with reference to FIG. 5A and module 450 populates the fields as described herein. In some examples, in block 610, the priority model module 450 determines whether the user 415 will provide manual priority settings. For example, the module 480 may request manual priority settings from the user 415. In some examples, the user 415 accepts the request for manual settings and the process 600 proceeds to block 615. In some other examples, the user 415 may decline to provide the manual settings via the module 480 and the process 600 proceeds to block 640 as described herein.

In some examples, in block 615, the priority model module 450 selects a linked device from the devices linked to the source device 330 or other devices in the secure device ecosystem 300. For example, the priority model module 450 may first select the target device 350 and request a manual setting from the user 415 via the module 480. In some examples, in block 620, the priority model module 450 receives a priority level for the device, such as a selected priority preference for the target device. For example, for the target device 350, the user 415 may provide a primary device priority preference, a secondary priority preference, tertiary priority preference, etc. via the module 480.

In some examples, in block 625, the priority model module 450 stores the priority level or priority preference in the priority model. For example, for the source device 330 the priority model module 450 may update the preference matrix 500 to the preference matrix 550 by storing the received priority level/preference in the field 542 indicating the preferred priority preference for the user 415 for the target device 350. As described above, in some examples, the preference matrix 550 and the received priority level from the user 415 is for a specific connection type, such as an audio connection. For other types of connections, the user may provide different priority preferences which are stored in a separate preference matrix or stored in the preference matrix 550 with an indication of which type of connection the priority preference is stored.

In some examples, in block 630, the priority model module 450 determines whether additional linked devices need a priority level. For example, the priority model module 450 may determine that the fields 540 and 541 (among other fields for linked pairs in the preference matrix 550) are not filled and proceed back to block 615 to continue requesting priority preferences from the user 415 until all additional linked devices have a priority level/preference stored in the preference matrix 550. Upon receiving priority levels for all linked devices, the process 600 proceeds to block 670 described herein.

Returning to block 610, as described above, in some examples, the user 415 may decline to provide manual priority settings or preferences for one or more of the linked devices and the priority model module 450 may use the AI/ML model 470 to determine or predict priority preferences for the linked devices. In some examples, in block 640, the priority model module 450 collects connection selections for each linked source/target device pair. For example, as the source device 330 connects to linked devices using automatic connections (connections via device settlings) or user selections, the priority model module 450 receives the connection selections for one or more target devices of the target devices, including the selections for target devices 350, 360 and 370.

In some examples, in block 645, the priority model module 450 trains the AI/ML model 470 using the collected selections. In some examples, the priority model module 450 trains the AI/ML model 470 using reinforcement learning to predict a relevant primary target device corresponding to a source device and connection type. In some examples, in block 650, the priority model module 450 predicts priority connections using the ML model generating, using an AI/ML model, a learned priority preference for the target device using the plurality of connection selections. In some examples, the process 600 may iteratively proceed through the blocks 645-660 to train the AI/ML model 470 and predict the priority preferences. In some examples, the priority model module 450 uses reinforcement learning techniques such that the AI/ML model 470 is a reinforcement AI/ML model. For example, the AI/ML model 470 learns to achieve a goal, such as correctly predicting the priority preference, in an uncertain and complex environment by performing the predictions and receiving feedback including positive reinforcement for correct selections (as compared to actual connections made to the target devices during a training period) and negative reinforcement for incorrect selections. In some examples, the priority model module 450 stores the learned priority preferences in the priority model, such as the preference matrix 550 for the source device 330.

In some examples, in block 655, the priority model module 450 utilizes the predicted priority levels for device connection selection. For example, the priority model module 450 and the connection module 460 uses a predicted priority preference to establish a connection to a target device for a given connection type. In some examples, in block 660, the priority model module 450 updates priority model based on prediction outcome. For example, if no change to the connection is made by the user 415 then the AI/ML model 470 is positively reinforced and the prediction is considered correct. In an example, where the user makes changes to the established connection, then the prediction is considered wrong and the model and the AI/ML model 470 is updated to try a different prediction.

In some examples, in block 670, the priority model module 450 utilizes the priority model for device connection selection. In some examples, the user made provide preferences as described in blocks 615-630, but the priority model module 450 and model 470 may continue to process the connections made by the source device 330 to various target devices and predict/update the priority model 455 according to learning preferences and prediction outcomes. For example, a user may indicate a that a target device is a primary target device for a connection type, but then consistently alter the connection. As the model module 450 and model 470 track and update this behavior, the priority model 455 may be updated such that the user 415 does not have to continue manually changing the connected target device or manually update the priority model 455.

FIG. 7 shows a flowchart illustrating an example process 700 performable by or at a network device for establishing a connection between a source and a target device. The operations of the process 700 may be implemented by a source device or its components as described herein. For example, the process 700 may be performed by a wireless communication device, such as the wireless communication device 1300 described with reference to FIG. 13, operating as or within a STA including any of the STAs 104 and 204 and source devices described with reference to FIGS. 1-3. In some examples, the process 600 also may be performed by a wireless AP such as one of the APs 102 or 202 described with reference to FIGS. 1 and 2.

In some examples, in block 705, the priority model module 450 scans for target devices within a connectable distance. For example, the priority model module 450 may scan a wireless medium for any target devices linked to the source device 330 in a secure device ecosystem. In some examples, the scan may include a scan of various types of radios and wireless mediums related to differing wireless communication standards including Wi-Fi, Bluetooth, cellular and other wireless standards. In some examples, the priority model module 450 detects or senses target devices within a connectable distance of the source device 330. For example, as discussed in relation to FIG. 4, the devices 350, 360, and 370 may all be within a connectable distance of the source device 330 such that the source device 330 may establish a connection to a selected target device.

In some examples, in block 710, the priority model module 450 determines if multiple linked devices are within a connectable distance. In some examples, only one device may be within a connectable distance of the source device 330. For example, the device 360 may be within a connectable distance of the source device 330 while the remaining target devices linked to the source device 330 are not detected in the scan of the wireless medium at block 705. In the example where only one target device is detected, the process 700 proceeds to block 715.

In some examples, in block 715, the source device 330 connects to the sole target device. For example, when only the device 360 is detected, the source device 330 connects or otherwise establishes a connection to the device 360. In some examples, the connection may be of a given connection type, such as an audio connection, a video connection, a multimedia connection or an immersive data stream connection based on a current use of the source device 330. In some examples, upon establishing the connection to the target device at block 715, the process 700 proceeds to block 760, which is described in more detail herein. Returning to block 710, in some examples, multiple target devices are detected within the connectable distances of the source device 330 and the process 700 proceeds to block 730.

In some examples, in block 730, the priority model module 450 determines whether a priority model is available for the source device. For example, the priority model module 450 may determine whether the priority model 455 is stored on the source device 330. In some examples, the priority model module 450 also may determine whether the priority module 455 is available for the source device 330 and a given connection type. For example, a priority model 455 may be available for an audio connection, but not available or stored on the source device 330 for a video connection. In an example, where a priority model is not available the process 700 proceeds to block 735.

In some examples, in block 735, the priority model module 450 obtains a priority model for the source device 330 and connection type. For example, the source device 330 may obtain a priority model 455 from other devices in the secure device ecosystem 300. In some examples, the priority model module 450 also may generate a priority model for the source device 330 and connection type as described with reference to process 600 in FIG. 6. In an example where the priority model 455 is available at block 730 or obtained at block 735, the process 700 proceeds to block 740.

In some examples, in block 740, the priority model module 450, using a priority model, determines whether a primary device is available. In some examples, module 450 uses a priority model in the form of a preference matrix, such as the preference matrix 550 described with reference to FIG. 5B. In some examples, the priority model module 450 determines which device of the scanned target devices has the highest priority or identifies the primary target device. For example, in the preference matrix 550, the source device 330 has target device 360 as a primary target device “1” as shown in field 540, target device 370 as a secondary target device “2” as shown in field 541, and device 350 as a tertiary target device “3” as shown in field 542. In an example where the primary target device, target device 360, is available or within a connectable distance, the process 700 proceeds to block 745.

In some examples, in block 745, the priority model module 450 connects the primary device. For example, the priority model module 450 selects the primary target device, device 360, and the module 460 establishes a connection of the connection type to the target device 360 and process 700 proceeds to block 750. In an example where the primary target device is not available, the process 700 proceeds to block 755, which is described in more detail herein.

In some examples, in block 750, the priority model module 450 determines whether to connect an additional device. In some implementations, the source device 330 may establish multiple connections of the connection type to multiple target devices. For example, the source device 330 may establish audio connections to both a headphone set and a speaker set for one audio stream such that audio connections are established to both devices. In some examples, the source device 330 may utilize connection settings to determine whether to establish multiple connections or provide a request to the user 415 via the UI module 480 to determine whether multiple connections are desired. For example, the source device 330 may receive a multiple connection approval input from the user 415 and proceed to establish an additional connection of the connection type to a secondary target device of at block 755.

In some examples, in block 755, the priority model module 450 connects a next available device. For example, when the primary device is not connected at block 745, the priority model module 450 may connect a next preferred device or secondary target device, such as the device 370 for connection. In an example where the primary device is connected at block 745 and an additional device connection is requested at block 750, the priority model module 450 also selects the next preferred device, such as the device 370 for connection. Upon selecting the device, the modules 450 and the connection module 460 establishes a connection or additional of the connection type to the next preferred or secondary target device, such as the connection 425 to the device 370. In some examples, at block 750 upon determining that no further target devices are to be connected the process 700 proceeds to block 760.

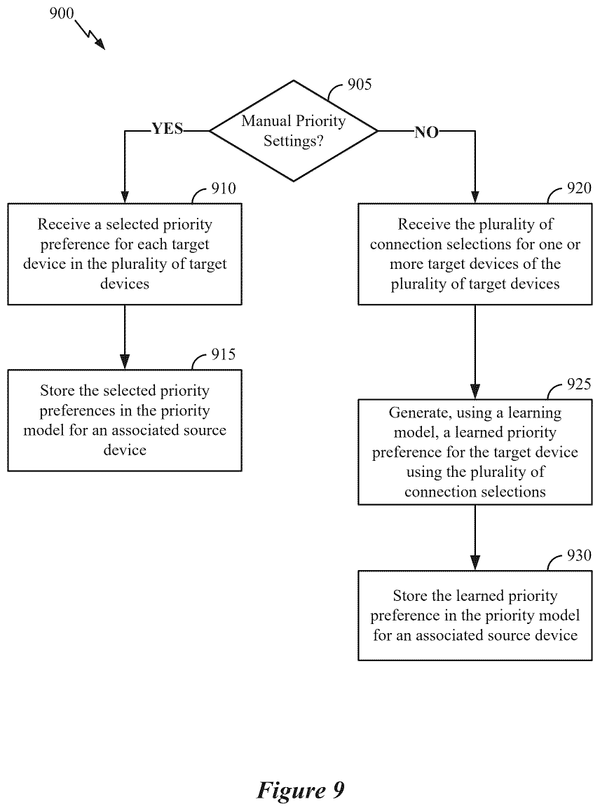

In some examples, in block 760, the priority model module 450 maintains the device connections established at either or both of blocks 745 and 755 and periodically proceeds to block 770 to determine whether a new connection session is initiated by the device. For example, the source device 330 may end a data stream of the connection type or periodically begin a new device session in order to scan for new or additional target devices. In an example where a new connection session has not begun at block 770, the process 700 returns to block 760. In an example where a new connection session has begun, the process 700 returns to block 705 to scan for target devices. Additional methods of establishing a connection between a source and a target device using a priority model are described in relation to FIGS. 10-12.

FIG. 8 shows a flowchart illustrating an example process 800 performable by or at a network device that supports generating a priority model for connecting a source device to a target device. The operations of the process 800 may be implemented by a network device or its components as described herein. For example, the process 800 may be performed by a wireless communication device, such as the wireless communication device 1300 described with reference to FIG. 13, operating as or within a STA including any of the STAs 104 and 204 and source devices described with reference to FIGS. 1-3. In some examples, the process 600 may be also performed by a wireless AP such as one of the APs 102 or 202 described with reference to FIGS. 1 and 2.

In some examples, in block 805, the network device scans a wireless medium for a plurality of target devices linked to a source device in a secure device ecosystem. For example, the source device 330 may scan a wireless medium for any target devices linked to the source device 330 or other source devices in the secure device ecosystem 300. In some examples, the scan may include a scan of various types of radios and wireless mediums related to differing wireless communication standards including Wi-Fi, Bluetooth, cellular and other wireless standards.

In some examples, in block 810, the network device receives a priority preference for each of the target devices in the plurality of target devices. In some examples, the network device generates a priority model for connecting a source device to a target device using the received priority preferences. For example, the network device may receive preference selections from a user as described with reference to blocks 615-630 of process 600 with reference to FIG. 6. In some examples, the network device receives priority preferences in the form of connection selection during regular use of the network device and connection to target device and predict priority preferences using the connection selections as described with reference to blocks 640-660 of process 600 with reference to FIG. 6.

In some examples, the priority model may include a preference matrix for a plurality of devices in the secure device ecosystem, such as the preference matrix 550 described with reference to FIG. 5B. In some examples, the priority model includes priorities preferences for a specific connection type from the plurality of target devices. In some examples, the connection type is related to a type of data exchanged between the source device and the target device. For example, the connection type may include any of an audio connection, a video connection, a multimedia connection, and an immersive data stream connection.

In some examples, in block 815, the network device broadcasts the priority model to the plurality of devices in the secure device ecosystem. For example, with reference to FIG. 3, each of the source devices 310, 320 and 330 and server 301 may broadcast or transmit any priority models generated or updated on the respective device to the other devices in the secure device ecosystem 300 in order to provide priority models or updated priority models throughout the secure device ecosystem 300.

FIG. 9 shows a flowchart illustrating an example process 900 performable by or at a network device that supports generating a priority model for connecting a source device to a target device. The operations of the process 900 may be implemented by a network device or its components as described herein. For example, the process 900 may be performed by a wireless communication device, such as the wireless communication device 1300 described with reference to FIG. 13, operating as or within a STA including any of the STAs 104 and 204 and source devices described with reference to FIGS. 1-3. In some examples, the process 600 may be also performed by a wireless AP such as one of the APs 102 or 202 described with reference to FIGS. 1 and 2.

In some examples, in block 905, the network device determines manual or selected priority preferences are provided to the network device. For example, the network device determines whether a will provide manual settings or selected priority preferences as described in block 610 of process 600. When manual settings are available at the network device the process 900 proceeds to block.

In some examples, in block 910, the network device receives a priority preference for each of the target devices in the plurality of target devices and stores the selected priority preferences in the priority model for an associated source device at block 915. In some examples, the network device generates a priority model for connecting the source device to the target device using the received priority preferences as described in blocks 615-626 of process 600. In some examples, the priority model may include a preference matrix for a plurality of devices in the secure device ecosystem, such as the preference matrix 550 described with reference to FIG. 5B. In some examples, the priority model includes priorities preferences for a specific connection type and includes an indication of the connection type such as an indication of an audio connection, a video connection, a multimedia connection, or an immersive data stream connection.

Returning to block 905, in an example where manual priority settings are not available at the network device, the process 900 proceeds to block 920. In some examples, in block 910, the network device receives a plurality of connection selections for one or more target devices of the plurality of target devices. For example, during use of a source device, the network device may collect connection selections from the source device to various target devices made by a user or device settings as described with relation to block 640 of process 600.

In some examples, in block 925, the network device generates, using a learning model, a learned priority preference for the target device using the plurality of connection selections. For example, the network device may use the AI/ML model 470 to learn/predict priority preferences as described with reference to blocks 645-655 of FIG. 6 to determine or generate a learned priority preference.

In some examples, in block 930, the network device stores the learned priority preference in the priority model for an associated source device. For example, the network device stores or updates priority preferences in a preference matrix, such as the preference matrix 550 in FIG. 5B, with learned priority preferences.

FIG. 10 shows a flowchart illustrating an example process 1000 performable by or at a source device that supports establishing a connection between the source and a target device. The operations of the process 1000 may be implemented by a source device or its components as described herein. For example, the process 1000 may be performed by a wireless communication device, such as the wireless communication device 1300 described with reference to FIG. 13, operating as or within a STA including any of the STAs 104 and 204 and source devices described with reference to FIGS. 1-3. In some examples, the process 600 may be also performed by a wireless AP such as one of the APs 102 or 202 described with reference to FIGS. 1 and 2.

In some examples, in block 1005, the source device scans a wireless medium for a plurality of target devices linked to the source device in a secure device ecosystem. In some examples, the network device scans for target devices within a connectable distance. For example, network device may scan a wireless medium for any target devices linked to the source device in the secure device ecosystem. In some examples, the scan may include a scan of various types of radios and wireless mediums related to differing wireless communication standards including Wi-Fi, Bluetooth, cellular and other wireless standards. In some examples, the network device may detect or senses target devices within a connectable distance of the source device. For example, as discussed in relation to FIG. 4, the devices 350, 360, and 370 may all be within a connectable distance of the source device 330 such that the source device 330 may establish a connection to a selected target device.

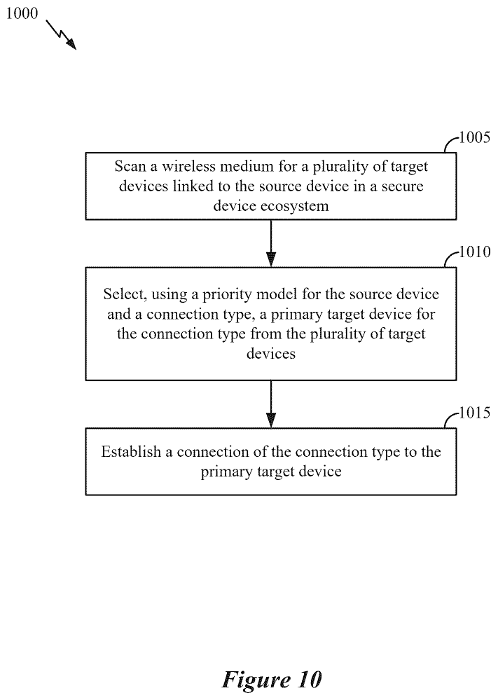

In some examples, in block 1010, the source device selects, using a priority model for the source device and a connection type, a primary target device for the connection type from the plurality of target devices. In some examples, the source device uses a priority model in the form of a preference matrix, such as the preference matrix 550 described with reference to FIG. 5B. In some examples, the source device determines which device of the scanned target devices has the highest priority or identifies the primary target device. For example, in the preference matrix 550, the source device 330 has target device 360 as a primary target device “1” as shown in field 540, target device 370 as a secondary target device “2” as shown in field 541, and device 350 as a tertiary target device “3” as shown in field 542. In some examples, the source device also may select a secondary target device from the plurality of target devices when a primary target device is not detected in the scan of the wireless medium. Additionally, the source device may select multiple target devices for a connection as described in process 1100 with reference to FIG. 11.

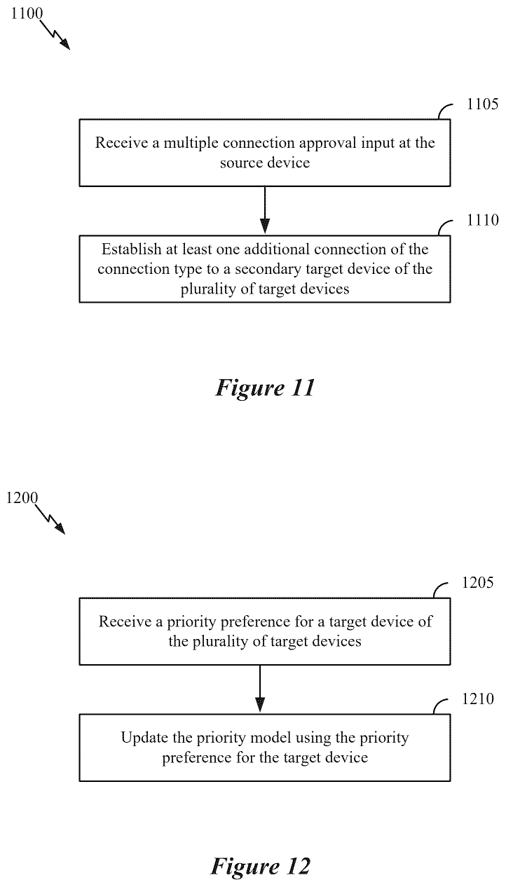

In some examples, in block 1015, the source device establishes a connection of the connection type to the primary target device. In some examples, the source device maintains the connection to the primary target device during a connection session as described in relation to blocks 760 and 77 of the process 700. In some examples, during the duration of the connection between the source device and the primary target device, the source device may receive a priority preference for a target device and update the priority model as described in process 1200 with reference to FIG. 12.

FIG. 11 shows a flowchart illustrating an example process 1100 performable by or at a source device that supports establishing a connection between the source and multiple target devices. The operations of the process 1100 may be implemented by a source device or its components as described herein. For example, the process 1100 may be performed by a wireless communication device, such as the wireless communication device 1300 described with reference to FIG. 13 operating as or within a STA including any of the STAs 104 and 204 and source devices described with reference to FIGS. 1-3. In some examples, the process 600 may be also performed by a wireless AP such as one of the APs 102 or 202 described with reference to FIGS. 1 and 2.

In some examples, in block 1105, the source device receives a multiple connection approval input at the source device. In some implementations, the source device may establish multiple connections of the connection type to multiple target devices. For example, the source device may establish audio connections to both a headphone set and a speaker set for one audio stream such that audio connections are established to both devices. In some examples, the source device may utilize connection settings to determine whether to establish multiple connections or provide a request to a user as described in relation to block 750 of the process 700. For example, the source device may receive a multiple connection approval input from the user and proceed to block 1110.

In some examples, in block 1110, the source device establishes at least one additional connection of the connection type to a secondary target device of the plurality of target devices. For example, as described in block 755 of the process 700, the source device establishes a connection or additional connection of the connection type to the next preferred or secondary target device, such as the connection 425 to the device 370.

FIG. 12 shows a flowchart illustrating an example process 1200 performable by or at a source device that supports updating a priority model at a source device. The operations of the process 1200 may be implemented by a source device or its components as described herein. For example, the process 1200 may be performed by a wireless communication device, such as the wireless communication device 1300 described with reference to FIG. 13, operating as or within a STA including any of the STAs 104 and 204 and source devices described with reference to FIGS. 1-3. In some examples, the process 600 may be also performed by a wireless AP such as one of the APs 102 or 202 described with reference to FIGS. 1 and 2.

In some examples, in block 1205, the source device receives a priority preference for a target device of the plurality of target devices. For example, after a priority model is generated for a source device, the user may manually provide an update to the priority model or an AI/ML model, such as the AI/ML model 470 may indicate that an update is needed to the priority model based on user behavior, etc.

In some examples, in block 1210, the source device updates the priority model using the updated priority preference for the target device. In some examples, upon updating the priority model, the source device may broadcast the updated model or updates to other devices in the secure device ecosystem, such as the other source devices in the secure device ecosystem 300.

FIG. 13 shows a block diagram of an example wireless communication device 1300 that supports generating and utilizing a priority model for connecting a source device to a target device. In some examples, the wireless communication device 1300 is configured to perform the process 600, 700, 800, 900, 1000, 1100 and 1200 respectively described with reference to FIGS. 8-12. The wireless communication device 1300 may include one or more chips, SoCs, chipsets, packages, components or devices that individually or collectively constitute or include a processing system. The processing system may interface with other components of the wireless communication device 1300, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1300 may transmit the information output from the chip. In such an example, the second interface may refer to an interface between the processing system of the chip and a reception component, such that the device 1300 may receive information that is passed to the processing system. In some such examples, the first interface also may obtain information, such as from the transmission component, and the second interface also may output information, such as to the reception component.

The processing system of the wireless communication device 1300 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1300 can be configurable or configured for use in a STA, such as the STA 104, or an AP, such as the AP 102 described with reference to FIG. 1. In some other examples, the wireless communication device 1300 can be an STA, AP or other network device that includes such a processing system and other components including multiple antennas. The wireless communication device 1300 is capable of transmitting and receiving wireless communications in the form of, for example, wireless packets. For example, the wireless communication device 1300 can be configurable or configured to transmit and receive packets in the form of physical layer PPDUs and MPDUs conforming to one or more of the IEEE 802.11 family of wireless communication protocol standards. In some other examples, the wireless communication device 1300 can be configurable or configured to transmit and receive signals and communications conforming to one or more 3GPP specifications including those for 5G NR or 6G. In some examples, the wireless communication device 1300 also includes or can be coupled with one or more application processors which may be further coupled with one or more other memories. In some examples, the wireless communication device 1300 further includes at least one external network interface coupled with the processing system that enables communication with a core network or backhaul network that enables the wireless communication device 1300 to gain access to external networks including the Internet.

The wireless communication device 1300 includes a memory component 1305, a network component 1310, the priority module 450, the connection module 460, the AI/ML model 470 and the user interface module 480. Portions of one or more of the components 1305, 1310, and modules 450, 460, 470 and 480 may be implemented at least in part in hardware or firmware. For example, the priority model module 450 may be implemented at least in part by a processor or a modem. In some examples, portions of one or more of the components 1305 and 1310 and modules 450, 460, 470 and 480 may be implemented at least in part by a processor and software in the form of processor-executable code stored in a memory.

The priority model module 450 is configurable or configured to generate and utilize a priority model for connecting a source device to a target device. For example, the priority model module 450 is configurable or configured to scan a wireless medium for a plurality of target devices linked to a source device in a secure device ecosystem and receive a priority preference for each of the target devices in the plurality of target devices. The priority model module 450 is also configurable or configured to generate a priority model for connecting a source device to a target device using the received priority preferences. The priority model module 450 and the network component 1310 are also configurable or configured to broadcast the priority model to the plurality of devices in the secure device ecosystem.

In some implementations, the priority model module 450 is also configurable or configured to scan a wireless medium for a plurality of target devices linked to the source device in a secure device ecosystem and select, using a priority model for the source device and a connection type, a primary target device for the connection type from the plurality of target devices. The connection module 460 is also configurable or configured to establish a connection of the connection type to the primary target device.

Implementation examples are described in the following numbered clauses:

Clause 1. A source device, including: a processing system that includes processor circuitry and memory circuitry that stores code, the processing system configured to cause the source device to: scan a wireless medium for a plurality of target devices linked to the source device in a secure device ecosystem; select, using a priority model for the source device and a connection type, a primary target device for the connection type from the plurality of target devices; and establish a connection of the connection type to the primary target device.

Clause 2. The source device of clause 1, where selecting the primary target device further includes: selecting a secondary target device from the plurality of target devices when a primary target device is not detected in the scan of the wireless medium.

Clause 3. The source device of any of clauses 1 and 2, where the processing system is further configured to cause the source device to: receive a multiple connection approval input at the source device; and establish at least one additional connection of the connection type to a secondary target device of the plurality of target devices.

Clause 4. The source device of any of clauses 1, 2 and 3, where the connection type includes a type of data exchanged between the source device and a target device, and where the connection type includes one or more of: an audio connection; a video connection; a multimedia connection, and an immersive data stream connection.

Clause 5. The source device of any of clauses 1, 2, 3 and 4, where the processing system is further configured to cause the source device to: receive a priority preference for a target device of the plurality of target devices; and update the priority model using the priority preference for the target device.

Clause 6. The source device of any of clauses 1, 2, 3, 4 and 5, where the priority model includes a preference matrix for a plurality of devices in the secure device ecosystem.

Clause 7. The source device of clause any of clauses 1, 2, 3, 4, 5 and 6, where the processing system is further configured to cause the source device to: update the priority model using a priority model update received from the secure device ecosystem.

Clause 8. A method for wireless communication by a source device, the method including: scanning a wireless medium for a plurality of target devices linked to the source device in a secure device ecosystem; selecting, using a priority model for the source device and a connection type, a primary target device for the connection type from the plurality of target devices; and establishing a connection of the connection type to the primary target device.

Clause 9. The method of clause 8, where selecting the primary target device further includes: selecting a secondary target device from the plurality of target devices when a primary target device is not detected in the scan of the wireless medium.

Clause 10. The method of any of clauses 8 and 9, where the method further includes: receiving a multiple connection approval input at the source device; and establishing at least one additional connection of the connection type to a secondary target device of the plurality of target devices.

Clause 11. The method of any of clauses 8, 9 and 10, where the connection type includes a type of data exchanged between the source device and a target device, and where the connection type includes one or more of: an audio connection; a video connection; a multimedia connection, and an immersive data stream connection.

Clause 12. The method of any of clauses 8, 9, 10 and 11, where the method further includes: receiving a priority preference for a target device of the plurality of target devices; and updating the priority model using the priority preference for the target device.

Clause 13. The method of any of clauses 8, 9, 10, 11 and 12, where the priority model includes a preference matrix for a plurality of devices in the secure device ecosystem.

Clause 14. The method of any of clauses 8, 9, 10, 11, 12 and 13, where the method further includes: updating the priority model using a priority model update received from the secure device ecosystem.

Clause 15. A non-transitory processor-readable storage medium including processor-readable instructions configured to cause one or more processors to measure a channel in a wireless communication system, including code for: scanning a wireless medium for a plurality of target devices linked to the source device in a secure device ecosystem; selecting, using a priority model for the source device and a connection type, a primary target device for the connection type from the plurality of target devices; and establishing a connection of the connection type to the primary target device.

Clause 16. The non-transitory processor-readable storage medium of clause 15, where selecting the primary target device further includes: selecting a secondary target device from the plurality of target devices when a primary target device is not detected in the scan of the wireless medium.

Clause 17. The non-transitory processor-readable storage medium of any of clauses 15 and 16, further including code for: receiving a multiple connection approval input at the source device; and establishing at least one additional connection of the connection type to a secondary target device of the plurality of target devices.

Clause 18. The non-transitory processor-readable storage medium of any of clauses 15, 16 and 17, where the connection type includes a type of data exchanged between the source device and a target device, and where the connection type includes one or more of: an audio connection; a video connection; a multimedia connection, and an immersive data stream connection.

Clause 19. The non-transitory processor-readable storage medium of any of clauses 15, 16, 17 and 18, further including code for: receiving a priority preference for a target device of the plurality of target devices; and updating the priority model using the priority preference for the target device.

Clause 20. The non-transitory processor-readable storage medium of any of clauses 15, 16, 17, 18 and 19, where the priority model includes a preference matrix for a plurality of devices in the secure device ecosystem.

Clause 21. The non-transitory processor-readable storage medium of any of clauses 15, 16, 17, 18, 19 and 20, further including code for: updating the priority model using a priority model update received from the secure device ecosystem.

Clause 22. An apparatus for wireless communication by a source device, including:
means for scanning a wireless medium for a plurality of target devices linked to the source device in a secure device ecosystem; means for selecting, using a priority model for the source device and a connection type, a primary target device for the connection type from the plurality of target devices; and means for establishing a connection of the connection type to the primary target device.

Clause 23. The apparatus of clause 22, where means for selecting the primary target device further includes: means for selecting a secondary target device from the plurality of target devices when a primary target device is not detected in the scan of the wireless medium.

Clause 24. The apparatus of any of clauses 23 and 24, further including: means for receiving a multiple connection approval input at the source device; and means for establishing at least one additional connection of the connection type to a secondary target device of the plurality of target devices.

Clause 25. The apparatus of any of clauses 23, 24 and 25, where the connection type includes a type of data exchanged between the source device and a target device, and where the connection type includes one or more of: an audio connection; a video connection; a multimedia connection, and an immersive data stream connection.

Clause 26. The apparatus of any of clauses 23, 24, 25 and 26, further including:
means for receiving a priority preference for a target device of the plurality of target devices;
and means for updating the priority model using the priority preference for the target device.

Clause 27. The apparatus of any of clauses 23, 24, 25, 26 and 27, where the priority model includes a preference matrix for a plurality of devices in the secure device ecosystem.

Clause 28. The apparatus of any of clauses 23, 24, 25, 26, 27 and 28, further including: means for updating the priority model using a priority model update received from the secure device ecosystem.

Clause 30. A network device, including: a processing system that includes processor circuitry and memory circuitry that stores code, the processing system configured to cause the network device to: scan a wireless medium for a plurality of target devices linked to a source device in a secure device ecosystem; receive a priority preference for target device in the plurality of target devices, a priority model for connecting the source device to a target device being generated using the received priority preferences; and broadcast the priority model to a plurality of source devices in the secure device ecosystem.

Clause 31. The network device of clause 30, where the priority preference includes a selected priority preference, and where generating the priority model further includes:
receiving a selected priority preference for each target device in the plurality of target devices;
and storing the selected priority preferences in the priority model for an associated source device.

Clause 32. The network device of any of clauses 30 and 31, where the priority preference for each of the target devices includes a plurality of connection selections, and where generating the priority model further includes: receiving the plurality of connection selections for one or more target devices of the plurality of target devices; generating, using a learning model, a learned priority preference for the target device using the plurality of connection selections; and storing the learned priority preference in the priority model for an associated source device.

Clause 33. The network device of any of clauses 30, 31 and 32, where the priority model includes a preference matrix for a plurality of devices in the secure device ecosystem.

Clause 34. The network device of any of clauses 30, 31, 32 and 33, where the priority model includes priorities preferences for a connection type from the plurality of target devices.

Clause 35. The network device of any of clauses 30, 31, 32, 33 and 34, where the connection type includes a type of data exchanged between a source device and the plurality of target devices, and where the connection type includes one or more of: an audio connection; a video connection; a multimedia connection; and an immersive data stream connection.

Clause 36. A method for wireless communication by a network device, the method including scanning a wireless medium for a plurality of target devices linked to a source device in a secure device ecosystem; receiving a priority preference for target device in the plurality of target devices, a priority model for connecting the source device to a target device being generated using the received priority preferences; and broadcasting the priority model to a plurality of source devices in the secure device ecosystem.

Clause 37. The method of clause 36, where the priority preference includes a selected priority preference, and where generating the priority model further includes: receiving a selected priority preference for each target device in the plurality of target devices; and storing the selected priority preferences in the priority model for an associated source device.

Clause 38. The method of any of clauses 36 and 37, where the priority preference for each of the target devices includes a plurality of connection selections, and where generating the priority model further includes: receiving the plurality of connection selections for one or more target devices of the plurality of target devices; generating, using a learning model, a learned priority preference for the target device using the plurality of connection selections; and storing the learned priority preference in the priority model for an associated source device.

Clause 39. The method of any of clauses 36, 37 and 38, where the priority model includes a preference matrix for a plurality of devices in the secure device ecosystem.

Clause 40. The method of any of clauses 36, 37, 38 and 39, where the priority model includes priorities preferences for a connection type from the plurality of target devices.

Clause 41. The method of any of clauses 36, 37, 38 and 39, where the connection type includes a type of data exchanged between a source device and the plurality of target devices, and where the connection type includes one or more of: an audio connection; a video connection; a multimedia connection; and an immersive data stream connection.

Clause 42. A non-transitory processor-readable storage medium including processor-readable instructions configured to cause one or more processors to measure a channel in a wireless communication system, including code for: scanning a wireless medium for a plurality of target devices linked to a source device in a secure device ecosystem; receiving a priority preference for target device in the plurality of target devices, a priority model for connecting the source device to a target device being generated using the received priority preferences; and broadcasting the priority model to a plurality of source devices in the secure device ecosystem.

Clause 43. The non-transitory processor-readable storage medium of clause 42, where the priority preference includes a selected priority preference, and where generating the priority model further includes: receiving a selected priority preference for each target device in the plurality of target devices; and storing the selected priority preferences in the priority model for an associated source device.

Clause 44. The non-transitory processor-readable storage medium of any of clauses 42 and 43, where the priority preference for each of the target devices includes a plurality of connection selections, and where generating the priority model further includes: receiving the plurality of connection selections for one or more target devices of the plurality of target devices; generating, using a learning model, a learned priority preference for the target device using the plurality of connection selections; and storing the learned priority preference in the priority model for an associated source device.

Clause 45. The non-transitory processor-readable storage medium of any of clauses 42, 43 and 44, where the priority model includes a preference matrix for a plurality of devices in the secure device ecosystem.

Clause 46. The non-transitory processor-readable storage medium of any of clauses 42, 43, 44 and 45, where the priority model includes priorities preferences for a connection type from the plurality of target devices.

Clause 47. The non-transitory processor-readable storage medium of any of clauses 42, 43, 44, 45 and 46, where the connection type includes a type of data exchanged between a source device and the plurality of target devices, and where the connection type includes one or more of: an audio connection; a video connection; a multimedia connection; and an immersive data stream connection.

Clause 48. An apparatus for wireless communication by a network device, the apparatus including: means for scanning a wireless medium for a plurality of target devices linked to a source device in a secure device ecosystem; means for receiving a priority preference for target device in the plurality of target devices, a priority model for connecting the source device to a target device being generated using the received priority preferences; and means for broadcasting the priority model to a plurality of source devices in the secure device ecosystem.

Clause 49. The apparatus of clause 48, where the priority preference includes a selected priority preference, and where means for generating the priority model further includes:
means for receiving a selected priority preference for each target device in the plurality of target devices; and means for storing the selected priority preferences in the priority model for an associated source device.

Clause 50. The apparatus of any of clauses 48 and 49, where the priority preference for each of the target devices includes a plurality of connection selections, and where means for generating the priority model further includes: means for receiving the plurality of connection selections for one or more target devices of the plurality of target devices; means for generating, using a learning model, a learned priority preference for the target device using the plurality of connection selections; and means for storing the learned priority preference in the priority model for an associated source device.

Clause 51. The apparatus of any of clauses 48, 49 and 50, where the priority model includes a preference matrix for a plurality of devices in the secure device ecosystem.

Clause 52. The apparatus of any of clauses 48, 49, 50 and 51, where the priority model includes priorities preferences for a connection type from the plurality of target devices.

Clause 53. The apparatus of any of clauses 48, 49, 50, 51 and 52, where the connection type includes a type of data exchanged between a source device and the plurality of target devices, and where the connection type includes one or more of: an audio connection; a video connection; a multimedia connection; and an immersive data stream connection.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A source device, comprising:
a processing system that includes processor circuitry and memory circuitry that stores code, the processing system configured to cause the source device to:
scan a wireless medium for a plurality of target devices linked to the source device in a secure device ecosystem;
select, using a priority model for the source device and a connection type, a primary target device for the connection type from the plurality of target devices; and
establish a connection of the connection type to the primary target device.

2. The source device of claim 1, wherein selecting the primary target device further comprises:
selecting a secondary target device from the plurality of target devices when a primary target device is not detected in the scan of the wireless medium.

3. The source device of claim 1, wherein the processing system is further configured to cause the source device to:
receive a multiple connection approval input at the source device; and
establish at least one additional connection of the connection type to a secondary target device of the plurality of target devices.

4. The source device of claim 1, wherein the connection type comprises a type of data exchanged between the source device and a target device, and wherein the connection type comprises one or more of:
an audio connection;
a video connection;
a multimedia connection, and
an immersive data stream connection.

5. The source device of claim 1, wherein the processing system is further configured to cause the source device to:
receive a priority preference for a target device of the plurality of target devices; and
update the priority model using the priority preference for the target device.

6. The source device of claim 1, wherein the priority model comprises a preference matrix for a plurality of devices in the secure device ecosystem.

7. The source device of claim 6, wherein the processing system is further configured to cause the source device to:
update the priority model using a priority model update received from the secure device ecosystem.

8. A network device, comprising:
a processing system that includes processor circuitry and memory circuitry that stores code, the processing system configured to cause the network device to:
scan a wireless medium for a plurality of target devices linked to a source device in a secure device ecosystem;
receive a priority preference for target device in the plurality of target devices,
a priority model for connecting the source device to a target device being generated using the received priority preferences; and
broadcast the priority model to a plurality of source devices in the secure device ecosystem.

9. The network device of claim 8, wherein the priority preference comprises a selected priority preference, and wherein generating the priority model further comprises:
receiving a selected priority preference for each target device in the plurality of target devices; and
storing the selected priority preferences in the priority model for an associated source device.

10. The network device of claim 8, wherein the priority preference for each of the target devices comprises a plurality of connection selections, and wherein generating the priority model further comprises:
receiving the plurality of connection selections for one or more target devices of the plurality of target devices;
generating, using a learning model, a learned priority preference for the target device using the plurality of connection selections; and
storing the learned priority preference in the priority model for an associated source device.

11. The network device of claim 8, wherein the priority model comprises a preference matrix for a plurality of devices in the secure device ecosystem.

12. The network device of claim 8, wherein the priority model comprises priorities preferences for a connection type from the plurality of target devices.

13. The network device of claim 12, wherein the connection type comprises a type of data exchanged between the source device and the plurality of target devices, and wherein the connection type comprises one or more of:
an audio connection;
a video connection;
a multimedia connection; and
an immersive data stream connection.

14. A method for wireless communication by a source device, comprising:
scanning a wireless medium for a plurality of target devices linked to the source device in a secure device ecosystem;
selecting, using a priority model for the source device and a connection type, a primary target device for the connection type from the plurality of target devices; and
establishing a connection of the connection type to the primary target device.

15. The method of claim 14, wherein selecting the primary target device further comprises:
selecting a secondary target device from the plurality of target devices when a primary target device is not detected in the scan of the wireless medium.

16. The method of claim 14, wherein the method further comprises:
receiving a multiple connection approval input at the source device; and
establishing at least one additional connection of the connection type to a secondary target device of the plurality of target devices.

17. The method of claim 14, wherein the connection type comprises a type of data exchanged between the source device and a target device, and wherein the connection type comprises one or more of:
an audio connection;
a video connection;
a multimedia connection, and
an immersive data stream connection.

18. The method of claim 14, wherein the method further comprises:
receiving a priority preference for a target device of the plurality of target devices; and
updating the priority model using the priority preference for the target device.

19. The method of claim 14, wherein the priority model comprises a preference matrix for a plurality of devices in the secure device ecosystem.

20. The method of claim 14, wherein the method further comprises:
updating the priority model using a priority model update received from the secure device ecosystem.
